(19) United States
(12) Patent Application Publication
(10) Pub. No.: US 2024/0026209 A1
(43) Pub. Date: Jan. 25, 2024

(54) PROCESS FOR THE PRODUCTION OF BACKFILLING PASTES FOR UNDERGROUND OPERATIONS AND METHOD FOR CONTROLLING THE FLOW OF BACKFILLING PASTES

(71) Applicant: SIKA TECHNOLOGY AG, Baar (CH)

(72) Inventors: Luis PEGADO, Brugg (CH); Patrick JUILLAND, Bern (CH); Sara ARCILA, Zürich (CH); Lukas FRUNZ, Dietlikon (CH); Arnd Bernd EBERHARDT, Winterthur (CH); Emmanuel GALLUCCI, Zürich (CH); Fabian ERISMANN, Zürich (CH); Annette WEINKAUF, Zürich (CH)

(73) Assignee: SIKA TECHNOLOGY AG, Baar (CH)

(21) Appl. No.: 18/255,746

(22) PCT Filed: Nov. 30, 2021
(86) PCT No.: PCT/EP2021/083468

§ 371 Date: Jun. 2, 2023

(30) Foreign Application Priority Data
Dec. 2, 2020 (EP) 20211371.8

(51) Int. Cl. C09K 8/467; C04B 28/04; C04B 18/12; C04B 24/26; C04B 22/06; C04B 22/08

(52) U.S. Cl. CPC C09K 8/467; C04B 28/04; C04B 18/12; C04B 24/2647; C04B 22/064; C04B 22/085

(57) ABSTRACT

A process for the production of backfilling pastes for underground operations, the process including or essentially consisting of the mixing of a) cement, b) tailings from underground operations, c) optionally extra water, d) at least one polycarboxylate ether, and e) calcium hydroxide; and a method for controlling the flow of a backfilling paste for underground operations, the method including at least one step of admixing an admixture including at least one polycarboxylate ether and calcium hydroxide to a mixture of cement, tailings, and water.

### TECHNICAL FIELD

The present invention relates to a process for the production of backfilling pastes for underground operations. The present invention also relates to a method for controlling the flow of a backfilling paste for underground operations.

### BACKGROUND OF THE INVENTION

The use of dewatered tailings for underground backfilling has become the standard for many underground cut and fill as well as long hole operations worldwide. Especially in the mining industry there is a constant need for efficient backfilling processes to fulfil safety and environmental targets as well as to optimize cost.

Underground backfilling is the process of filling underground excavations with a cementitious paste comprising the tailings, that is comprising cement and the excavated and extracted residual materials of underground operations. Pastes used for underground backfilling may thus contain a wide range of different minerals of various sizes, i.e. the tailings. Still, the production of pastes, i.e. the mixing of tailings, cement, water, needs to run smoothly. The resulting pastes have to be pumped underground to fill any voids without clogging of mixing and conveying equipment, and finally, the paste has to cure to a desired strength to provide for safe further underground operations. Various admixtures, known from the cement and concrete industry, have thus been used in the production of backfilling pastes.

One particularly useful type of admixture used are superplasticizers for cement, especially so-called polycarboxylate esters or polycarboxylate ethers (PCE). Such use of PCE in backfilling pastes is known from WO 2009/068380.

However, it is known that PCE may interact in an unfavourable way with different mineral materials, such as, in particular, phyllosilicates. Owing to the wide range of different minerals present in tailings from underground operations, there is a constant need for processes to efficiently provide backfilling pastes. This is especially the case where tailings may interact with water reducers, especially with superplasticizers, in an unfavourable way.

### SUMMARY OF THE INVENTION

It is thus an object of the present invention to provide processes for the production of backfilling pastes comprising cement and tailings, that can ensure an enhanced flow of such pastes. This object has surprisingly been solved by the process of claim 1.

It is another object of the present invention to provide a method for the control of the flow of backfilling pastes comprising cement and tailings. This object has surprisingly been solved by the method of claim 15.

The present invention thus relates to a process for the production of backfilling pastes for underground operations, said process comprising or essentially consisting of the mixing of
a) cement,
b) tailings from underground operations,
c) optionally extra water,
d) at least one polycarboxylate ether, and
e) calcium hydroxide.

The present invention also relates to a method for controlling the flow of a backfilling paste for underground operations, said method comprising at least one step of admixing an admixture comprising
a) at least one polycarboxylate ether, and
b) calcium hydroxide to a mixture of cement, tailings, and water.

The use of calcium hydroxide together with at least one polycarboxylate ether has in particular the advantage that the flow (measurable for example as the slump flow) of a backfilling paste thus obtained is increased as compared to the flow of the same backfilling paste comprising the same polycarboxylate ether but no calcium hydroxide. This is especially the case for backfilling pastes comprising tailings from underground operations which comprise phyllosilicates.

Further aspects of the present invention are subject of the independent claims.

Preferred embodiments are subject of the dependant claims.

### DETAILED DESCRIPTION OF THE INVENTION

In a first aspect the present invention relates to a process for the production of backfilling pastes for underground operations, said process comprising or essentially consisting of the mixing of
a) cement,
b) tailings from underground operations,
c) optionally extra water,
d) at least one polycarboxylate ether, and
e) calcium hydroxide.

The term backfilling paste within the present context refers to materials which are used in underground operations to fill any voids and which have a paste like, flowable consistency under standard conditions. Voids may originate from the excavation process in underground operations or they may occur naturally, for example as caves. Backfilling pastes within the present context are pastes which harden with time to form a solid material. Especially, the hardening of backfilling pastes occurs via a hydration mechanism of cement and/or cementitious materials.

Cement within the present context preferably comprises or consists of Portland cement, alumina cement, and/or calcium sulphoaluminate cement. Portland cement can be any cement according to standard EN 197-1. In particular type CEM I, CEM II, CEM III, CEM IV, or CEM V. Portland cements according to other international standards, e.g. ASTM standards or Chinese standards, can be used as well. The term “Ordinary Portland Cement”, within the present context, refers to a cement of type CEM I. The term “alumina cement” stands in particular for a cement with an aluminium content, measured as Al₂O₃, of at least 30 wt.-%, especially at least 35 wt.-%, in particular 35-58 wt.-%.

Preferably, the alumina cement is alumina cement according to standard EN 14647. According to certain embodiments, mixtures of Portland cements, alumina cements, and calcium sulphoaluminate cement are used. The weight ratios of Portland cement, alumina cement, and calcium sulphoaluminate cement is not particularly limited and may vary in wide ratios. The cement may additionally comprise pozzolanic materials, latent hydraulic materials, and/or gypsum. According to preferred embodiments, the content of Portland cement in a cement of the present invention is at least 20 wt.-%, preferably at least 35 wt.-%, more preferably at least 65 wt.-%, still more preferably at least 85 wt.-%, especially at least 95 wt.-%.

According to embodiments, the cement consists of (in each case relative to the total dry weight of the cement) 80-99 w %, preferably 85-95 w % of Ordinary Portland Cement, 1-20 w %, preferably 5-15 w %, especially 5-7.5 w % of gypsum, and optionally a maximum of 7.5 w % of mineral additions, especially limestone.

According to special embodiments, the cement consists of Ordinary Portland Cement.

According to other embodiments, the cement consists of a mixture of Ordinary Portland Cement and slag, especially granulated blast furnace slag, with a content of slag between 5-80 wt.-%, preferably between 21-70 wt.-%, especially 50-65 wt.-%, in each case relative to the total dry weight of the cement.

According to other embodiments, the cement comprises a mixture of Ordinary Portland Cement, slag, especially granulated blast furnace slag, and gypsum. Preferably, the content of Ordinary Portland Cement relative to the total dry weight of such a mixture is at least 20 wt.-%, preferably at least 35 wt.-%, more preferably at least 65 wt.-%, still more preferably at least 85 wt.-%, especially at least 95 wt.-%.

It is preferred that the cement according to the present invention does not comprise mixtures of fly ash and alumina cement.

The term tailings from underground operations pertains to any mineral material excavated from an underground operation such as, for example, excavation of a tunnel, a borehole or a mine. Typically, in mining operations, tailings are the residual mineral materials after extraction of the valuable materials from the ore. Tailings can vary in chemical composition and physical appearance in a wide range. Generally, the chemical composition will largely depend on the location and chemical composition of the deposit from where the tailings were extracted. Furthermore, the chemical composition may also be influenced by the extraction methods as well as subsequent storage time and conditions. The physical appearance, including particle size and shape, typically also depends on the mechanical treatment of the ore and the tailings.

According to preferred embodiments of the present invention, tailings from underground operations comprise quartz and phyllosilicates. Other minerals such as, for example, magnetite and gypsum may additionally be present. It is, however, preferable that the amount of gypsum in such tailings is low. A low amount is an amount of less than 5 wt.-%, preferably less than 2 wt.-%, more preferably less than 1 wt.-% relative to the total dry weight of the tailings. The phyllosilicates are layered silicate minerals and, more specific, phyllosilicate minerals based on tetrahedral MO₄ sheets (M=Si⁴⁺, Al³⁺) and octahedral M(O,OH)₆ sheets (M=A³⁺, Mg²⁺, Fe^{2+/3+}, etc.). They differ inter alia from each other by their way of stacking the tetrahedral and octahedral sheets, which strongly influences their capacity of adding or losing water molecules or cations from their structure. Phyllosilicates within the present context preferably are chosen from the list consisting of the minerals of the smectite group (such as montmorillonite, nontronite, beidellite, saponite, hectorite and sauconit), vermiculites, kaolinite, serpentines (such as serpentine and lizardite), palygorskite, sepiolite, talc, pyrophyllite, chlorites, mica (such as muscovite or biotite), interlayer-deficient mica like illite, glauconite, celadonite, and phengite. Water within the context of a process of the present invention refers to any water present in such process regardless of its origin. The water in a process of the present invention may originate from the cement, the tailings, the aqueous solution of calcium hydroxide, the slurry of calcium hydroxide in water, the water present where aqueous solutions or dispersions of the at least one polycarboxylate ether are used, and/or any extra water added in addition. The term “extra water” relates to water added as such. In other words “extra water” is water not present in the cement, the tailings, the aqueous solution of calcium hydroxide, the slurry of calcium hydroxide in water, the water present where aqueous solutions or dispersions of the at least one polycarboxylate ether are used.

The total amount of water in a process of the present invention is not particularly limited and may be adjusted according to the other constituents of the mix and the desired flow. The “total amount of water” relates to the amount of water in a process of the present invention and originating from the cement, the tailings, an aqueous solution of calcium hydroxide, a slurry of calcium hydroxide in water, an aqueous solution or dispersion of the at least one polycarboxylate ether, and the water added in addition. In other words, the “total amount of water” refers to the total amount of water present during the mixing of cement, tailings, water, calcium hydroxide, and at least one polycarboxylate ether.

Typically, the total amount of water in a process of the present invention may vary in the range of 10-50 wt.-%, preferably 20-35 wt.-%, relative to the total dry weight of the tailings.

According to preferred embodiments of the present invention, water is added as an aqueous solution of calcium hydroxide or a slurry of calcium hydroxide in water and/or as an aqueous solution or dispersion of the at least one polycarboxylate ether. It is especially preferred, that the total amount of water is added as an aqueous solution of calcium hydroxide or a slurry of calcium hydroxide in water and/or as an aqueous solution or dispersion of the at least one polycarboxylate ether. It is, however, also possible that the total amount of water originates from moisture of the tailings, water present in the aqueous solution of calcium hydroxide or the slurry of calcium hydroxide in water and/or water present where an aqueous solution or dispersion of the at least one polycarboxylate ether is used.

If additional water is added, such water can be any water available such as distilled water, purified water, tap water, mineral water, spring water, well water, salt water, wastewater, and ground water. The use of wastewater is possible only in cases where the composition of such wastewater is known and where none of the impurities contained may impart the functionality of any other component of the composition of the present invention. The use of salt water is only possible where the risk of corrosion of steel elements is low. It is especially preferred within the present context to use water extracted from the underground operation, for example water pumped out from a mining operation. Preferably, the water extracted from underground operations is filtered before use to remove tailings.

The polycarboxylate ether is in particular a comb polymer having a polycarboxylate backbone and polyether side chains, wherein the polyether side chains are preferably linked to the polycarboxylate backbone via ester, ether and/or amide groups. Polycarboxylate ethers are commercially available.

Within the present context, the term polycarboxylate ether also encompasses polycarboxylate esters. A polycarboxlate ether (PCE) is a superplasticizer for cement and may act as a water reducer. The at least one polycarboxylate ether of the present invention comprises the following partial structural units or consists thereof:
a) a partial structural unit S1 of formula (I) in a mole fraction of a

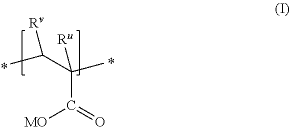

b) a partial structural unit S2 of formula (II) in a mole fraction of b

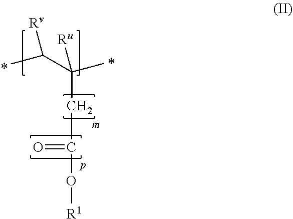

c) a partial structural unit S3 of formula (III) in a mole fraction of c

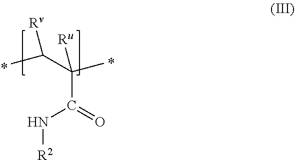

d) a partial structural unit S4 of formula (IV) in a mole fraction of d

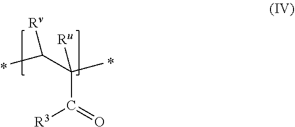

wherein
   M independent from each other is H⁺, an alkali metal ion, alkaline earth metal ion, a di- or trivalent metal ion, an ammonium ion or an organic ammonium group,
   each R^{u} independent from the others is hydrogen or a methyl group,
   each R^{v} independent from the others is hydrogen or COOM,
   m=0, 1 or 2,
   p=0 or 1,
   R¹ and R² independent from each other are a C₁ to C₂₀-alkyl group, -cycloalkyl group, -alkylaryl group or -[AO]ₙ—R⁴, wherein A=C₂ to C₄-alkylene, R⁴ is H, a C₁ to C₂₀-alkyl group, -cyclohexyl group or -alkylaryl group, and n=2-250, wherein R¹ and/or R² or at least a part of R¹ and/or R² is preferably -[AO]ₙ—R⁴,
   R³ independent from each other is NH₂, —NR⁵R⁶, —OR⁷NR⁸R⁹,
      wherein R⁵ and R⁶ independent from each other are a C₁ to C₂₀-alkyl group, -cycloalkyl group, -alkylaryl group or -aryl group; or a hydroxyalkyl group or a acetoxyethyl group (CH₃—CO—O—CH₂—CH₂—) or a hydroxy-isopropyl group (HO—CH(CH₃)—CH₂—) or an acetoxyisopropyl group (CH₃—COO—CH(CH₃)—CH₂—); or R⁵ and R⁶ together form a ring, the nitrogen being a part thereof, to form a morpholine or imidazoline ring;
      R⁷ is a C₂-C₄-alkylene group,
      R⁸ and R⁹ each are independent from each other a C₁ to C₂₀-alkyl group, -cycloalkyl group, -alkylaryl group, -aryl group or a hydroxyalkyl group,
   and wherein a, b, c and d represent mole fractions of the respective partial structural units S1, S2, S3 and S4,
   wherein a/b/c/d=(0.1-0.9)/(0.1-0.9)/(0-0.8)/(0-0.8), preferably a/b/c/d=(0.3-0.9)/(0.1-0.7)/(0-0.6)/(0-0.4),
   provided that a+b+c+d=1.

Thus the at least one polycarboxylate ether used in a process of the present invention preferably has a structure as described above.

According to preferred embodiments a particular class of polycarboxylate ethers is used, wherein the polycarboxylate ether comprises or consists of
a) a partial structural unit S1 of formula (I) in a mole fraction of

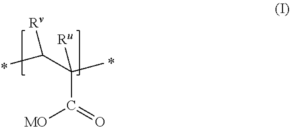

b) a partial structural unit S2 of formula (II) in a mole fraction of b

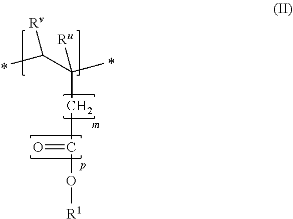

wherein

M independent from each other is H⁺, an alkali metal ion, alkaline earth metal ion, a di- or trivalent metal ion, an ammonium ion or an organic ammonium group, wherein M is preferably H⁺ or Na⁺;

each R^{u} independent from the others is hydrogen or a methyl group, each R^{v} is hydrogen;

m=1 or 2, preferably 1;

p=0;

R¹ is -[AO]ₙ—H, wherein A=C₂ to C₄-alkylene, preferably C₂H₄, and n is from 20 to 150, more preferably from 40 to 90; and

the molar ratio a/b of the mole fraction a of the partial structural unit S1 to the mole fraction b of the partial structural unit S2 is in the range from 6/1 to 2.5/1, preferably from 5/1 to 3/1, provided that a+b=1.

In particularly preferred embodiments, A is C₂H₄, and n is 50 to 60, e.g. approximately 54, with a molar ratio a/b of about 1:0.28, e.g. 1:0.25 to 1:0.30.

The following preferred embodiments applies to both the general definition of the polycarboxylate ether and the particular class of polycarboxylate ether as defined above, unless otherwise stated.

The sequence of the partial structural units S1, S2, S3 and S4 for the general definition or of the partial structural units S1 and S2 for the particular class may be alternating, blockwise or random. In principle, it is also possible that in addition to the partial structural units S1, S2, S3 and 54 for the general definition or to the partial structural units S1 and S2 for the particular class further structural units are present.

The weight proportion of the partial structural units S1, S2, S3, and S4 together for the general definition or of the partial structural units S1 and S2 together for the particular class is preferably 50 to 100% by weight, more preferably 90 to 100% by weight and still more preferably 95 to 100% by weight with respect to the total weight of the polycarboxylate ether.

According to a further preferred embodiment, the polycarboxylate ether is free of aromatic compounds and/or aromatic structural units.

The weight average molecular weight (Mw) of the polycarboxylate ether is preferably 5000-150′000 g/mol, more preferably 10′000-100′000 g/mol. The weight average molecular weight can be determined by gel permeation chromatography (GPC).

Methods for preparing the polycarboxylate ether are known to the skilled person. The preparation may, for example, be carried out by radical polymerization of the corresponding monomers of formula (Iₘ), (IIₘ), (IIIₘ) and/or (IVₘ) or of formula (Iₘ) and (IIₘ), respectively, resulting in a polycarboxylate ether having the partial structural units S1, S2, S3 and S4, or the partial structural units S1 and 52, respectively, preferably in the mole fractions indicated above. The residues R^{u}, R^{v}, R¹, R², R³, M, m and p are defined as described above.

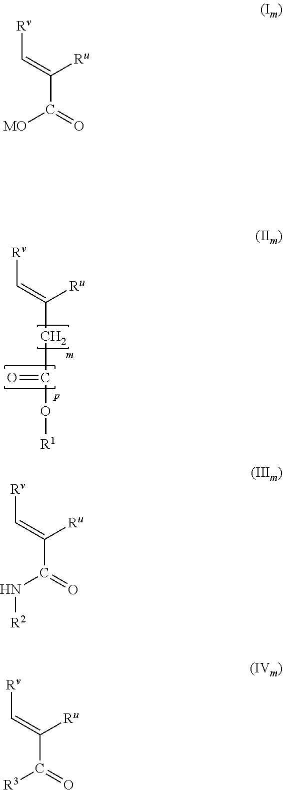

It is also possible to prepare the polycarboxylate ether by polymer-analogous reaction of a polycarboxylic acid or salt of formula (V), wherein R^{v}, R^{u} and M are defined as described above and n represents the polymerization degree of the polymer.

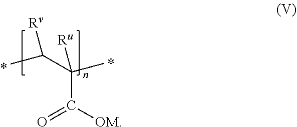

In the polymer-analogous reaction a polycarboxylic acid or salt of formula (V) is esterified and/or amidated with the corresponding alcohols or amines (e.g. HO—R¹, H₂N—R², H—R³) and then optionally neutralized or partially neutralized (depending on the type of residue M e.g. with metal hydroxides or ammonia). Details on the polymer-analogous reaction are disclosed e.g. in EP 1138697 B1 on page 7, line 20, to page 8, line 50, and in the examples thereof, or in EP 1061089 B1 on page 4, line 54, to page 5, line 38, and in the examples thereof. In a variant thereof, as described in EP 1348729 A1 on page 3 to page 5 and in the examples thereof, the polycarboxylate ether can be prepared in the solid state of matter. The disclosures of the patent publications mentioned are herewith enclosed by reference. The preparation by polymer-analogous reaction is preferred within the present context.

It is particularly preferred to use the at least one polycarboxylate ether of the present invention in the form of an aqueous solution or dispersion. In other words, according to preferred embodiments, in a process of the present invention, the at least one polycarboxylate ether is used in the form of an aqueous solution or dispersion. The solid content of such an aqueous solution or dispersion may vary in a wide range. It is, for example, possible for the solids content to be in the range of 10-70 wt.-%, preferably 20-60 wt.-%.

Calcium hydroxide can be added in a process of the present invention in the form of an aqueous solution, as a slurry in water, or as a solid. It is especially preferred to add the calcium hydroxide in a process of the present invention in the form of an aqueous solution or as a slurry in water.

An aqueous solution of calcium hydroxide in water may be of any suitable concentration. However, according to especially preferred embodiments, the aqueous solution of calcium hydroxide is a saturated solution of calcium hydroxide in water. It is preferred in a process of the present invention that the aqueous solution of calcium hydroxide is a saturated solution at 23° C. and 1013 mbar. A saturated aqueous solution of calcium hydroxide has a pH of appr. 12.5. The soluble content of calcium hydroxide is appr. 1.62 g/L.

A slurry of calcium hydroxide in water refers to a saturated solution of calcium hydroxide in water with additional solids of calcium hydroxide and/or calcium oxide present. Preferably, the solids of calcium hydroxide and/or calcium oxide are suspended in the slurry.

Where calcium hydroxide is added in solid form, there is no particular limitation on the fineness or particle size of the calcium hydroxide. It is, however, preferred in such a case that the calcium hydroxide is a powder. It I also possible to add calcium oxide instead of calcium hydroxide as a solid.

According to preferred embodiments, cement and tailings are mixed in a weight ratio of cement to tailings in the range of 1:8.5 to 1:50. In other words, the cement content, based on the total dry weight of cement and tailing is between 2-12 wt.-%, preferably 3.5-8 wt.-%. The cement content should be kept as low as possible for cost reason. However, a certain amount of cement has to be added to ensure that the backfilling paste will harden to a desired compressive strength. The desired compressive strength as measured according to EN 12190 can be in the range of 0.2-8 MPa, preferably 0.4 to 5 MPa.

According to preferred embodiments, in a process of the present invention, the dosage of the at least one polycarboxylate ether is in the range of 0.1-8 wt.-%, preferably 0.2-5 wt.-%, especially 0.5-4 wt.-%, relative to the total dry weight of cement.

According to preferred embodiments, in a process of the present invention, a weight ratio of the calcium hydroxide is higher than 0.1 wt.-%, preferably higher than 0.3 wt.-%, more preferably higher than 0.5 wt.-%, especially higher than 0.7 wt.-%, in each case relative to the total dry weight of cement. A weight ratio of calcium hydroxide should not exceed 10 wt.-%, preferably 5 wt.-%, especially 1.5 wt.-%, in each case relative to the total dry weight of cement. A suitable dosage range for the calcium hydroxide thus may be 0.1-10 wt.-%, preferably 0.3-5 wt.-%, more preferably 0.5-5 wt.-%, especially 0.7-1.5 wt.-%, in each case relative to the total dry weight of cement.

It has been found that the order of addition of the components of the backfilling paste has a significant influence on the slump flow performance. Especially, it has been found that a higher slump flow can be achieved in a process of the present invention if in a first mixing step cement, tailings, and water are intermixed, calcium hydroxide, in the form of a solid, an aqueous solution or a slurry in water, preferably a slurry in water or a saturated aqueous solution, is admixed to the mixture thus obtained, and at least one polycarboxylate ether is then admixed to the mixture thus obtained.

According to a preferred embodiment, a process of the present invention thus is characterized in that
1) first cement, tailings, and water are mixed
2) calcium hydroxide is admixed to the mixture obtained in 1),
3) at least one polycarboxylate ether is admixed to the mixture obtained in 2).

All embodiments and preferred features as described above also pertain to this process.

According to another preferred embodiment, a process of the present invention is characterized in that
1) first cement, tailings, and calcium hydroxide are mixed,
2) at least one polycarboxylate ether is admixed to the mixture obtained in 1).

All embodiments and preferred features as described above also pertain to this process.

Suitable mixers to be used in a process of the present invention are not particularly limited. Suitable mixers are, for example, Hobart mixer, portable concrete mixer, mixing truck, mixing bucket, paddle mixer, jet mixer, screw mixer, auger mixer, horizontal single shaft mixer, twin shaft paddle mixer, vertical shaft mixer, ribbon blender, orbiting mixer, change-can mixer, tumbling vessel, extruders, vertical agitated chamber or air agitated operations. Mixing can be continuously, semi-continuously or batch-wise. Continuous mixing offers the advantage of a high material throughput. A process of the present invention thus preferably is a process where the mixing is done in a continuous mixing process.

In a second aspect the present invention relates to a backfilling paste for underground operations, obtained by a process as described above.

A backfilling paste of the present invention preferably has a paste like, flowable consistency. The slump flow is a measure for the consistency of a backfilling paste of the present invention. Especially, the slump flow of a backfilling paste of the present invention is increased by a minimum of 5%, preferably 10%, more preferably 25%, especially 30% as compared to the slump flow of a similar backfilling paste not prepared to a process according to the present invention. Slump flow can be measured, for example, according to standard EN 12350-5 or in an Abrams mini cone.

In yet another aspect the present invention relates to an admixture to be used in a process for the preparation of a backfilling paste for underground operations.

Said admixture comprising
a) at least one polycarboxylate ether, and
b) calcium hydroxide.

The calcium hydroxide in an admixture of the present invention can be present in the form of an aqueous solution, a slurry in water, or as a solid, preferably in the form of an aqueous solution or as a slurry in water. Especially, the calcium hydroxide can be in the form of a saturated aqueous solution of calcium hydroxide at 23° C. and 1013 mbar.

All embodiments and preferred features as described above also pertain to this admixture.

The admixture may be a one component admixture comprising the at least one polycarboxylate ether and calcium hydroxide in one compartment. In cases where the admixture is a one component admixture, it is preferred that such one component admixture is prepared shortly before its use in a process of the present invention. The term “shortly before” should be understood to mean less than 7 days, preferably less than 3 days, especially less than 24 hours before.

The admixture of the present invention may be a two component admixture comprising the at least one polycarboxylate ether in a first compartment and calcium hydroxide in a separate, second compartment. It is especially preferred that an admixture of the present invention is a two component admixture. This has the advantage that the shelf life of the admixture is improved. This has the further advantage that the order of addition of the at least one polycarboxylate ether and of calcium hydroxide can be adjusted. Especially, the calcium hydroxide can be added to a mixture of cement, tailing, and water before the addition of the at least one polycarboxylate ether.

In a last aspect the present invention relates to a method for controlling the flow of a backfilling paste for underground operations, said method comprising at least one step of admixing an admixture as described above to a mixture of cement, tailings, and water.

The method of controlling the flow is especially a method of increasing the flow at a given content of cement, tailings, and water. The method of controlling the flow can also be a method of maintaining the flow at increased content of cement or tailings and/or decreased content of water. That is a method of maintaining the flow at increased solids content. The flow can be measured, for example as slump flow according to standard EN 12350-5 or in an Abrams mini cone. A maintained flow at increased solids content will allow for better attainment of the desired compressive strength without compromise on the application properties.

Control of the flow is important, as backfilling pastes are typically mixed above ground and then pumped underground. It is important that during pumping and filling there is no clogging of the pumping equipment. It is thus especially preferred, if the flow is maintained on the same level over a prolonged period of time, preferably for the time needed to pump the backfilling paste to the place of application. It is, of course, also important, that the flow is maintained on a similar level when using different tailings, especially tailings with different mineralogical composition.

All embodiments as described above also pertain to this method.

The invention will further be described by a way of illustrative examples, which are however not to be construed as limiting in any way to the scope of the present application.

### EXAMPLES

The following table 1 gives an overview of the raw materials used.

TABLE 1
raw materials

| | |
|---|---|
| Cement-1 | Cockburn Minecem |
| | (20-40 wt.-% Ordinary Portland Cement; 50-70 wt.-% |
| | granulated blast furnace slag; 5-7 wt.-% gypsum) |
| Cement-2 | Cockburn General Purpose Cement type GP |
| | (85-93 wt.-% Ordinary Portland Cement; 5-7 wt.-% |
| | gypsum; max. 7.5 wt.-% mineral addition) |
| PCE | Aqueous solution (solids content as indicated in the |
| | examples) of copolymer resulting from esterification of |
| | polyacrylic acid (Mn = 5000 g/mol) and |
| | methoxypolyethylene glycol (Mn = 5000 g/mol) to yield a |
| | molar ratio of acid:ester of 13.5 |
| Tailings | Extracted mineral from mining operation; appr. mineral |
| | composition by weight: 50 wt.-% quartz, 38.8 wt.-% |
| | phyllosilicates (lizardite, kaolinite, talc, biotite/muscovite, |
| | chlorite), 8.5 wt.-% other silicates (anorthite, actinolite) 2.5 |
| | wt.-% magnetite, 0.2 wt.-% gypsum |
| aq Ca(OH)₂ | Saturated solution of Ca(OH)₂ in water (appr. 0.02M), pH = |
| | 12.6 |
| aq NaOH | 0.1M solution of NaOH in water, pH = 13 |
| aq Ca(NO₃)₂ | 0.1M solution of Ca(NO₃)₂ in water |

The slump flow of pastes was measured with a Mini Abrams cone with a height of 58 mm, a diameter at the lower end of 38 mm and with a diameter at the upper end of 19 mm. For the measurements, all surfaces and the cone were pre-wetted with water, then filled with the respective paste and slowly lifted immediately. In case of flowable pastes, the cone was lifted appr. 2 cm and the paste was allowed to flow out. The diameter of the resulting cake was determined within a few seconds and noted as the slump flow. Measurements were performed at 21° C./50% r.h.

### Examples 1-1 to 1-5

Examples 1-1 to 1-5 were prepared to show the general feasibility of increasing the slump flow by the combined addition of aqueous calcium hydroxide and PCE to a backfilling paste.

Backfilling pastes were prepared by mixing 5.2 g of cement-1 and 128 g of dry tailings with water or the aqueous solutions as indicated in below table 2 respectively on a Heidolph mixer at 1000 rpm for 30 seconds. The amount of aqueous PCE solution (solids content 29.9 wt.-%) indicated in table 2 was then added dropwise to this mix within 30 seconds. The resulting mix was mixed for another 30 seconds.

TABLE 2
Examples 1-1 to 1-5 and results

| | 1-1* | 1-2 | 1-3* | 1-4 | 1-5* |
|---|---|---|---|---|---|
| Water [g] | 30 | 0 | 0 | 5 | 0 |
| aq Ca(OH)₂ [g] | 0 | 30 | 0 | 25 | 0 |
| aq NaOH [g] | 0 | 0 | 30 | 0 | 0 |
| aq Ca(NO₃)₂ [g] | 0 | 0 | 0 | 0 | 30 |
| PCE [g] | 0.358 | 0.361 | 0.361 | 0.361 | 0.361 |
| Slump flow [mm] | 76 | 105 | 79 | 92 | 46 |

*comparison, not according to the invention

From the example of table 2 it becomes clear that the addition of Ca(OH)₂ leads to a much increased slump flow of the backfilling paste comprising tailings and PCE. Example 1-4 shows that the effect is also present at a lower dosage of Ca(OH)₂ even though to a lesser extent. Comparative example 1-3 shows that the effect is not purely related to the increase of pH while comparative example 1.5 shows that Ca(NO₃)₂ does not have this effect.

### Examples 1-6 to 1-8

Examples 1-5 to 1-8 were prepared to show that different types of cement can be used in a process of the present invention and lead to different results.

Examples 1-5 to 1-8 were prepared in the same way as examples 1-1 to 1-5 above with the difference that cement-2 was used instead of cement-1 and the amounts of additional water, Ca(OH)₂ solution and NaOH solution as indicated in table 3 were used.

TABLE 3
Examples 1-6 to 1-8 and results

| | 1-6* | 1-7 | 1-8 |
|---|---|---|---|
| Water [g] | 30 | 0 | 5 |
| aq Ca(OH)₂ [g] | 0 | 30 | 25 |
| aq NaOH [g] | 0 | 0 | 0 |
| PCE [g] | 0.438 | 0.438 | 0.434 |
| Slump flow [mm] | 73 | 136 | 136 |

*comparison, not according to the invention

From the example of table 3 it becomes clear that the addition of Ca(OH)₂ leads to a much increased slump flow of the backfilling paste comprising tailings and PCE also in cases where a cement with high content of Ordinary Portland Cement is used. Examples 1-7 and 1-8 show that this is also the case where a lower dosage of Ca(OH)₂ is used. This is different from where a cement comprising ground granulated blast furnace slag is used (cf examples 1-2 and 1-4 with examples 1-7 and 1-8). In any case, the effect on mixtures comprising cement based on Portland clinker is more pronounced.

### Examples 1-9 to 1-12

Examples 1-9 to 1-12 were prepared to show that the order of addition of aqueous calcium hydroxide and PCE to a backfilling paste is important.

Process 1: Backfilling pastes were prepared by mixing 5.2 g of cement-2 and 128 g of dry tailings on a Heidolph mixer at 300 rpm for 30 seconds. To this dry mix were added 5 g of aqueous PCE solution (solids content 2.64 wt.-%) and the amount of water and aqueous Ca(OH)₂ indicated in below table 4. The resulting mixture was mixed on a Heidolph mixer at 1000 rpm for 1 minute.

Process 2: Backfilling pastes were prepared by mixing 5.2 g of cement-2 and 128 g of dry tailings on a Heidolph mixer at 300 rpm for 30 seconds. To this dry mix was added the amount of water and aqueous Ca(OH)₂ indicated in below table 4. The resulting mixture was mixed on a Heidolph mixer at 1000 rpm for seconds. To this mixture was added 5 g of aqueous PCE solution (solids content 2.64 wt.-%). The resulting mix was mixed for another 30 seconds.

Process 3: Backfilling pastes were prepared by mixing 5.2 g of cement-2, 128 g of dry tailings, the amount of water and aqueous Ca(OH)₂ indicated in below table 4 on a Heidolph mixer at 1000 rpm for 30 seconds. To this mix was added 0.44 g of aqueous PCE solution (solids content 29.9 wt.-%). The resulting mix was mixed for another 30 seconds.

TABLE 4
Examples 1-9 to 1-12 and results

| | 1-9* | 1-10 | 1-11 | 1-12 |
|---|---|---|---|---|
| Process | 3 | 1 | 2 | 3 |
| Water [g] | 30 | 0 | 0 | 5 |
| aq Ca(OH)₂ [g] | 0 | 25 | 25 | 25 |
| Slump flow [mm] | 73 | 79 | 103 | 136 |

*comparison, not according to the invention

It can be seen from the results of the above table 4 that the order of addition of the aqueous calcium hydroxide solution and the PCE is of great importance and that an order of addition according to process 2 and especially process 3 leads to a higher slump flow as compared to an order of addition according to process 1. It is thus advantageous to first mix the cement, tailings, Ca(OH)₂ and the main part of water, and add PCE in a last step.

1. A process for the production of backfilling pastes for underground operations, the process comprising or essentially consisting of the mixing of
a) cement,
b) tailings from underground operations,
c) optionally extra water,
d) at least one polycarboxylate ether, and
e) calcium hydroxide.

2. A process according to claim 1, wherein the at least one polycarboxylate ether comprises the following partial structural units or consists thereof:
a) a partial structural unit S1 of formula (I) in a mole fraction of a 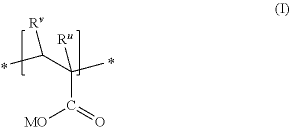
b) a partial structural unit S2 of formula (II) in a mole fraction of b 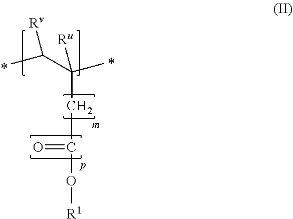
c) a partial structural unit S3 of formula (III) in a mole fraction of c 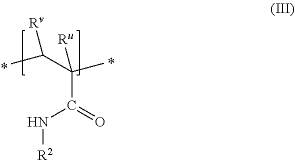
d) a partial structural unit S4 of formula (IV) in a mole fraction of d 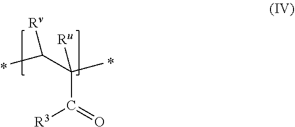
wherein
M independent from each other is H⁺, an alkali metal ion, alkaline earth metal ion, a di- or trivalent metal ion, an ammonium ion or an organic ammonium group,
each R^{u} independent from the others is hydrogen or a methyl group,
each R^{v} independent from the others is hydrogen or COOM,
m=0, 1 or 2,
p=0 or 1,
R¹ and R² independent from each other are a C₁ to C₂₀-alkyl group, -cycloalkyl group, -alkylaryl group or -[AO]ₙ—R⁴, wherein A=C₂ to C₄-alkylene, R⁴ is H, a C₁ to C₂₀-alkyl group, -cyclohexyl group or -alkylaryl group, and n=2-250, wherein R¹ and/or R² or at least a part of R and/or R² is [AO]ₙ—R⁴,
R³ independent from each other is NH₂, —NR⁵R⁶, —OR‘NR’R⁹,
wherein R⁵ and R⁶ independent from each other are a C₁ to C₂O-alkyl group, -cycloalkyl group, -alkylaryl group or -aryl group; or a hydroxyalkyl group or a acetoxyethyl group (CH₃—CO—O—CH₂—CH₂—) or a hydroxy-isopropyl group (HO—CH(CH₃)—CH₂—) or an acetoxyisopropyl group (CH₃—CO—O—CH(CH₃)—CH₂—); or R⁵ and R⁶ together form a ring, the nitrogen being a part thereof, to form a morpholine or imidazoline ring;
R⁷ is a C₂-C₄-alkylene group,
R⁸ and R⁹ each are independent from each other a C₁ to C₂₀-alkyl group, -cycloalkyl group, -alkylaryl group, -aryl group or a hydroxyalkyl group,
and wherein a, b, c and d represent mole fractions of the respective partial structural units S1, S2, S3 and S4,
wherein a/b/c/d=(0.1-0.9)/(0.1-0.9)/(0-0.8)/(0-0.8)
provided that a+b+c+d=1.

3. A process according to claim 1, wherein the cement content, based on the total dry weight of cement and tailings is between 2-12 wt. %.

4. A process according to claim 1, wherein the dosage of the at least one polycarboxylate ether is in the range of 0.1-8 wt.-%, relative to the total dry weight of cement.

5. A process according to claim 1, wherein the calcium hydroxide is added in the form of an aqueous solution, as a slurry in water, or as a solid.

6. A process according to claim 5, wherein the aqueous solution of calcium hydroxide is a saturated aqueous solution of calcium hydroxide at 23° C. and 1013 mbar.

7. A process according to claim 1, wherein
1) first cement, tailings, and, if present, extra water are mixed
2) calcium hydroxide is admixed to the mixture obtained in 1),
3) at least one polycarboxylate ether is admixed to the mixture obtained in 2).

8. A process according to at claim 1, wherein
1) first cement, tailings, if present extra water, and calcium hydroxide are mixed,
2) at least one polycarboxylate ether is admixed to the mixture obtained in 1).

9. A process according to claim 1, wherein the mixing is done in a continuous mixing process.

10. A process according to claim 1, wherein the tailings comprise or essentially consist of quartz and phyllosilicates

11. A process according to claim 10, wherein the phyllosilicates are chosen from the list consisting montmorillonite, nontronite, beidellite, saponite, hectorite and sauconit vermiculites, kaolinite, serpentines, lizardite, palygorskite, sepiolite, talc, pyrophyllite, chlorites, mica, muscovite, biotite, illite, glauconite, celadonite, and phengite.

12. A process according to claim 1, wherein the cement consists of (in each case relative to the total dry weight of the cement) 80-99 w % of Ordinary Portland Cement, 1-20 w % of gypsum, and optionally a maximum of 7.5 w % of mineral additions.

13. A process according to claim 1, wherein the dosage range for the calcium hydroxide is between 0.1-10 wt.-%, in each case relative to the total dry weight of cement

14. A backfilling paste for underground operations, obtained by a process according to claim 1.

15. An admixture to be used in a process according to claim 1, the admixture comprising
a) at least one polycarboxylate ether, and
b) calcium hydroxide.

16. An admixture according to claim 15, wherein the calcium hydroxide is in the form of an aqueous solution or an aqueous slurry.

17. The admixture according to claim 15, wherein it is a two component admixture with the at least one polycarboxylate ether in a first compartment and the calcium hydroxide in a separate, second compartment.

18. A method for controlling the flow of a backfilling paste for underground operations, the method comprising at least one step of admixing an admixture as claimed in claim 15 to a mixture of cement, tailings, and water.
